(19) United States
(12) Patent Application Publication
(10) Pub. No.: US 2013/0227394 A1
(43) Pub. Date: Aug. 29, 2013

(54) METHOD, SYSTEM AND COMPUTER PROGRAM PRODUCT FOR REPLACING BANNERS WITH WIDGETS

(71) Applicant: Victor Sazhin Group Ltd., (US)

(72) Inventors: Victor V. Sazhin, Moscow (RU); Sergey Nechaev, Novosibirsk (RU)

(73) Assignee: Victor Sazhin Group Ltd., Tortola (VG)

(21) Appl. No.: 13/858,063

(22) Filed: Apr. 7, 2013

Related U.S. Application Data
(63) Continuation-in-part of application No. 13/269,639, filed on Oct. 10, 2011, now abandoned.
(60) Provisional application No. 61/391,652, filed on Oct. 10, 2010.

(51) Int. Cl. G06F 17/24

(52) U.S. Cl. CPC G06F 17/24
USPC 715/234

(57) ABSTRACT

A method and computer program product for customizing web pages based on user preferences without having any adverse effects on space and layout of the original page. The web pages are customized on the client site by having ad banners replaced by widgets of the same size. A special page customization widget application is installed on a personal computer. Upon a launch of the widget application, the application performs a comprehensive scan of a user computer. User preferences are determined based results of the scan. Pages downloaded by a user are scanned for presence of the ad banners. Location and size of the ad banners are determined and the ad banners are replaced by widgets of the same size. The widgets are populated by content downloaded into the widgets based on the user preferences.

### CROSS-REFERENCE TO RELATED APPLICATIONS

This application is a continuation-in-part of U.S. patent application Ser. No. 13/269,639, filed on Oct. 10, 2011, which is a non-provisional of U.S. Provisional Patent Application No. 61/391,652, filed on Oct. 10, 2010, which is incorporated by reference herein in its entirety.

### BACKGROUND OF THE INVENTION

1. Field of the Invention

The present invention is related to Internet web development, and more particularly, to a method, system and computer program product for customizing web pages by replacing advertisement banners with useful widgets.

2. Background Art

An era of expansion of Internet commerce brings a lot of inconvenience to regular user. In particular, it becomes annoying for users to view web pages that have numerous advertising banners some of which are implemented with flash or animation features. These commercial banners slow down computers, take up some space that can be occupied by content of a page and generally distract users.

The commercial banners can be suppressed, but it changes the layout of the web page and leaves empty blocks of space that are still not filled with content. Thus active content space of the page does not change. The unpleasant issues caused by the commercial flashing banners have been partly addressed by applications that randomly replace commercial banners by “social conscious” banners with fewer flash features and animations.

For example, a banner advertising some questionable services or products can be replaced by a banner directed, for example, to preserving nature, protecting children, etc. Thus, when the page is updated and downloaded from the server to the user's computer, it presents the information that user is hopefully more interested in than in the potentially irritating original banner.

This conventional method is illustrated in FIG. 1. Users of personal computers 101 and 102 access web pages 111 and 112 over the Internet. The web pages reside on Internet sites on a web server 103. The users of the computers 101 and 102 download pages 111 and 112 to their personal computers for viewing. Once the pages are downloaded, a special application (or a browser plug-in) implemented on the user computers 101 and 102 replaces the advertisement banners by downloading them from another server 104. Thus, the users of the computers 101 and 102 are protected from viewing objectionable and/or annoying banners.

However, this approach only provides some less annoying advertisements to users and does not provide any useful information that can occupy the space freed up on the page from the original ads. Additionally, many users would like to see notifications from their social network sites (such as, for example Facebook or Twitter) or other sites requiring membership (for example, stock quotes sites). Conventionally, this is done by browser plug-ins providing these features through the tool bars. This is not very convenient, as the tool bars and other plug-in features interfere with the browser and take up extra screen space in addition to the ads.

Many users would prefer a possibility of seeing some useful information on web pages instead of ads that take up space. Accordingly, there is a need in the art for a method, system and a computer program product for automatically replacing commercial banners with customized user information without reducing web page space available for rendering content.

### SUMMARY OF THE INVENTION

Accordingly, the present invention is related to Internet web development, and more particularly, to a method, system and computer program product for customizing web pages by replacing commercial advertisement banners with customized useful information that substantially obviates one or more of the disadvantages of the related art.

In one embodiment, there is provided a method and computer program product for customizing web pages based on user preferences without having any adverse effects on space and layout of the original page. The web pages are customized on the client site by having the ads replaced by the widgets of the same size. A special page customization application is installed on a personal computer. The page customization application can be downloaded from a server and then installed and launched on a personal computer.

Upon a launch of the client-side application, the application performs a comprehensive scan of a user computer. The scan information can be, e.g., the geographical area and the time zone where user lives, the language user speaks and reads, the areas of user's personal interest (most visited sites, Internet forums, subscriptions, information feeds, the feeds the user is subscribed to, the sites bookmarked by the user, the Internet services employed by the user and user login and password information for these services, etc.).

The results of the scan are used for determining preferred user content. Location and size of the ad banners are determined and the banners are replaced by the widgets displaying some of the preferred user content. Thus, browser functionality is not affected and no extra space is taken by the widgets. The content substitution can use, for example, (a) full replacement, when the original content is removed completely from the page and the new content is inserted instead with the web page layout preserved (b) overlaying of the content, when the original content is covered and new content is placed over the original content while giving the user an option to make the original content visible again; (c) full removal, when original content is removed completely and nothing is inserted in its place.

Additionally, the user's social sub-networks of choice can be determined also based on the information connected to the user's mail box or any other Internet service accounts the user has (including, for example, social book marking services, My Space accounts, Facebook accounts, etc.). Thus, the social sub-networks notifications offered to the user through the widgets can be a close match to the needs and interests of the user. The special behavior on certain sites and/or web pages, e.g., Facebook user's profile page, Google search results page, etc., is provided by the client-side application. For example, the site behavior may be expressed as inserting additional search results from Bing, Twitter, Wikipedia and/or other sources in Google's search results page; inserting a block with current information from other social networks (such as Twitter, MySpace and/or others) into the Facebook user's profile page.

Additional features and advantages of the invention will be set forth in the description that follows, and in part will be apparent from the description, or may be learned by practice of the invention. The advantages of the invention will be realized and attained by the structure particularly pointed out in the written description and claims hereof as well as the appended drawings.

It is to be understood that both the foregoing general description and the following detailed description are exemplary and explanatory and are intended to provide further explanation of the invention as claimed.

### BRIEF DESCRIPTION OF THE ATTACHED FIGURES

The accompanying drawings, which are included to provide a further understanding of the invention and are incorporated in and constitute a part of this specification, illustrate embodiments of the invention and together with the description serve to explain the principles of the invention.

In the drawings:

FIG. 1 illustrates a conventional method for replacing ads on web pages;

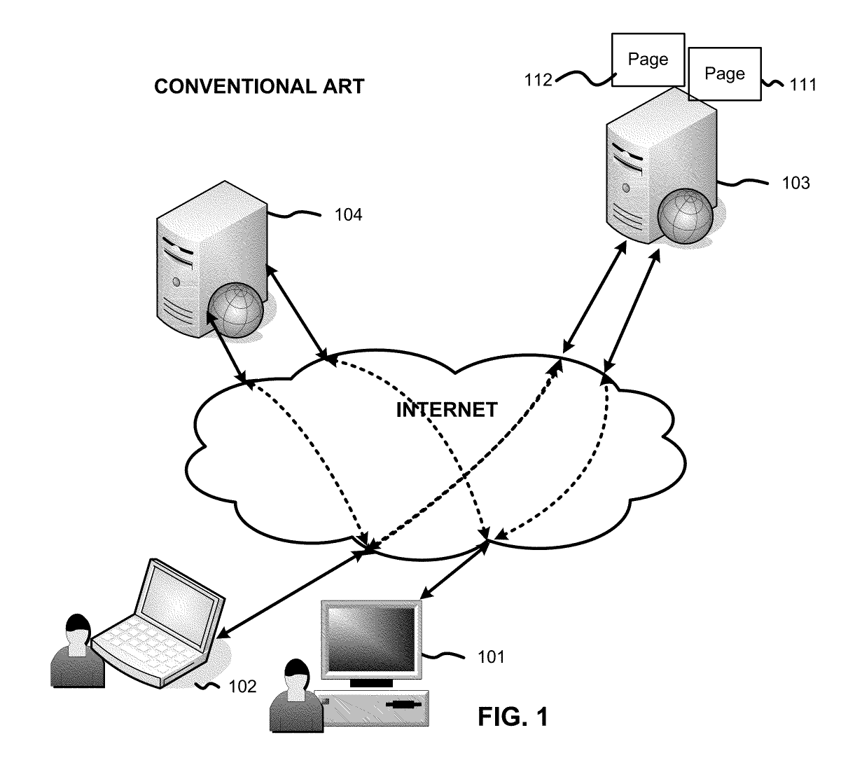

FIG. 2 illustrates a method for replacing commercial ads by widgets, in accordance with the exemplary embodiment;

FIG. 3 illustrates a flow chart of the method for replacing commercial ads by widgets, in accordance with the exemplary embodiment;

FIG. 4 illustrates an exemplary computer system that can be used for implementing the invention.

### DETAILED DESCRIPTION OF THE PREFERRED EMBODIMENTS

Reference will now be made in detail to the preferred embodiments of the present invention, examples of which are illustrated in the accompanying drawings.

In one embodiment, there is provided a method and computer program product for customizing web pages based on user preferences without having any adverse effects on space and layout of the original page. The start pages are customized on the client side by a software application that replaces ad banners with widgets of the same size. A special widget software application is installed on a personal computer. The application can be downloaded from a server and then installed and launched on a personal computer.

Upon a launch of the application, the page customization (i.e., widget forming) application performs a comprehensive scan of a user computer. The scan information can be, e.g., the geographical area and the time zone where user lives, the language the user speaks and reads, the areas of user's personal interest (most visited sites, Internet forums, subscriptions, information feeds, the feeds the user is subscribed to, the sites bookmarked by the user, the Internet services employed by the user and user login and password information for these services, etc.).

The results of the scan are used for determining preferred user content. Location and size of the ad banners are determined and the banners are replaced by widgets of the same size displaying some of the preferred user content. Thus, browser functionality is not affected and no extra space is taken by the widgets. Also, current user activity (for example, search requests, content of viewed pages) may be used to determine preferred user content.

Additionally, the user's social sub-networks of choice can be determined also based on the information connected to the user's mail box or any other Internet service accounts the user has (including, for example, social book marking services, My Space accounts, Facebook accounts, etc.). Thus, the social sub-networks notifications offered to the user through the widgets can be a close match to the needs and interests of the user.

Additionally (or instead of scanning the user's computer), the system can execute scripts or show iframes from a remote server, passing to the server some information about the ad blocks to be replaced (coordinates and size) user and the page that the user is looking at the moment. Then the remote server (acting as an intermediary online service) can show to the user different types of widgets according to its business logic. The current location of the user can be determined from his IP address, while language and other preferences can be accessed from the browser headers and cookies. Connection to particular social networks (e.g., Twitter, Facebook, MySpace, MoiKrug, etc.) can be done using JavaScript and particular social network API in a manner that would not require the user to transfer his login and password to the widget. For example, this can be done by registering its online application with the social network and then passing a user (who has not yet been authenticated) to the social network site for authorizing the application to be connected to his user account on the social network website.

The online service can choose which widgets to show the user based on the block size (i.e., width/height and/or other properties), user behavior data, user preferences transmitted or set in the online application, etc. It can either show the information widget to the user itself or give the browser HTML or JavaScript code that will pass the information required to another service (for example, a 3^{rd} party), which will actually show the widget to the user. For example the online service in its IFRAME can create another IFRAME of the same size, and the source URL will include the address of the desired service and the desired parameters.

The final widgets to be shown can be customized specifically to fit into different block sizes. As an example news widget for 460×68 pixels can show 1 or two headlines while widget for 728×80 pixels can show up to four headlines and/or screenshots. A weather widget for 100×100 pixels can contact current day weather, while a 250×250 pixels weather widget can show a forecast for several days. The intermediary online service can have information from widget peers on which peer can fill-in widget for what size.

The client application or online service can enable the user to set what kinds of widgets he wants to see instead of ads and, possibly, prioritize them. Also, a user can decide whether he wants all ads to be replaced or only some percentage of them and/or only some ad types (e.g. flash ads, graphics ads, text ads). Also, the user can choose whether an application should completely remove ad blocks it cannot replace (for example, due to ad block size that is not supported by any available widget) or leave them on the page.

The client software can do all the ad detection and replacement by itself or rely on third party software (as adblock) for part of this task. Also, depending on browser and user settings, it can either block the original ads from being shown or place the widgets on top (i.e., in front) of the ads. For example it is possible to block the ad from showing in Firefox, but not in some versions of Internet Explorer.

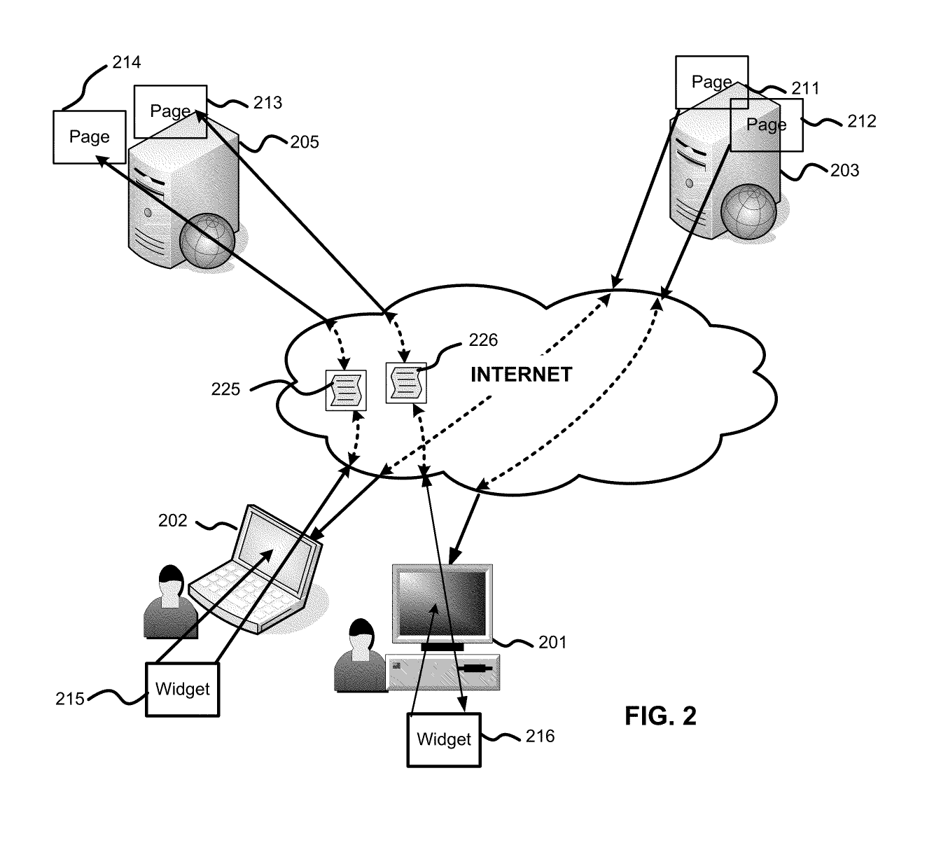

FIG. 2 illustrates a method for replacing commercial ads by widgets, in accordance with the exemplary embodiment.

Personal computers 201 and 202 are scanned by the widget application (or plug-in) installed on these computer systems. The results of the scan are analyzed and sorted out. User preference profiles are created based on the scan results. Pages 211 and 212 are downloaded from a server 203 to respective user computers 201 and 202. The pages 211 and 212 are scanned for presence of the commercial ad banners. If the ad banners are detected, the size and location of the banners are recorded. It is worth noting that while banners can, in theory, be any size, in practice almost 100% of the banners are of a handful of standard sizes, making it easier to select the widgets of a proper size.

Then the banners are replaced by widgets 215 and 216 of the same size. The widgets appear on the web pages in the same location as the ad banners and occupy exactly the same space on the page. Content 225 and 226 from web pages 213 and 214 is downloaded into the widgets 215 and 216 from the server 214. The content 225 and 226 is selected based on the user preferences. Thus, only the information relevant to the users is rendered through the widgets that replace useless ad banners.

The layout of downloaded web pages, advantageously, remains the same. Note that the widgets can render content downloaded from different servers. Alternatively, users can provide URLs of the preferred sites in order to view the content through the widgets.

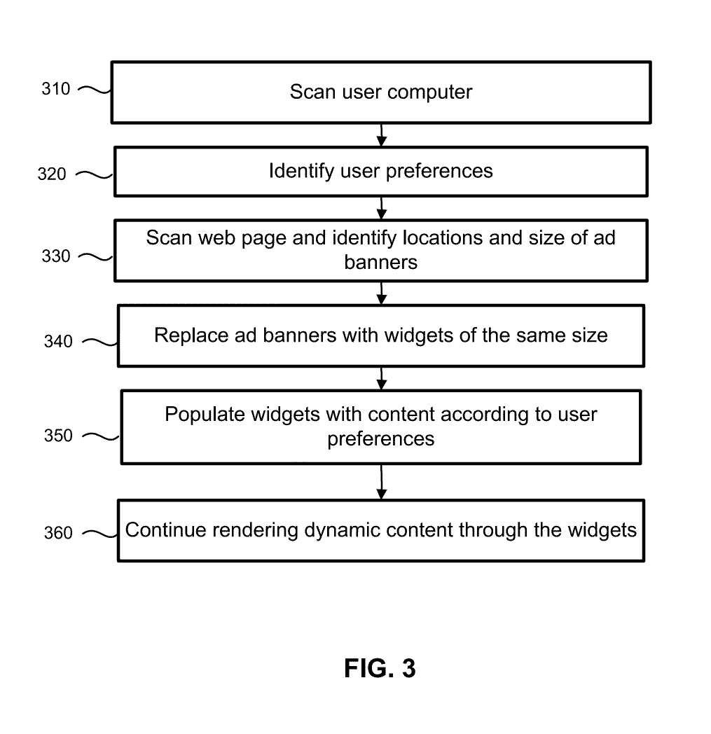

FIG. 3 illustrates a flow chart of the method for replacing commercial ads by widgets, in accordance with the exemplary embodiment. A user computer is scanned in step 310. User preferences are identified based on results of the scan in step 320. Web pages downloaded to the user computer are scanned and locations and sizes of the ad banners are determined in step 330.

The ad banners are replaced with the widgets of the same size in step 340. Note that the ad banners come in several fixed sizes. The replacing widgets are selected for each banner size. The size and location of the banners are determined during web page scan. The widgets are populated with the content downloaded based on user preferences in step 350. The widgets continue to render dynamic content to the user in step 360 for as along, as the user remains on the page.

The scan process, for example, may be done as follows if client software is implemented as an extension (or a plug-in or an add-on) for the user's preferable browser:
the client software is waiting for the web page DOM (Document Object Model, a tree representation of the web page) ready;
the DOM is scanned for all elements, which may contain advertising information, such as images, flash blocks, iframes, etc.;
each such potential element that has been found is processed by an analysis module, which determines if the block should be replaced;
when these steps are completed, the client software starts to monitor web page's changes, which can be made dynamically by the page's javascript, by third-party software or by the use of other techniques (such as a deferred/lazy resources loading, etc.), after the page is downloaded to the user's browser. Such changes can be made, for example, by a timer, by some specific event (e.g., new mail notification when the user is viewing the mail box web interface), or as a response to the user's actions (e.g., click the button or link on the web page, mouse hover on the elements, etc.);
when the client software detects the page's change (e.g. adding, removing or modifying the page's contents in part or in the entirety) as described below, it performs processing of modified area of the page or performs reprocessing of the whole page to find and replace new advertising blocks, which might have been inserted during detected dynamic change.

The analysis module determines whether the specified block is an advertisement or not and whether or not it should be replaced by widget. The decision may be based on recognition of the known URLs (e.g., known to be associated with advertising content), HTML tags and their properties (e.g., check flashVars property of Flash objects, etc.), CSS rules (Cascading Style Sheets rules), applied to the element, template masks, results of a string search (e.g., presence of the words or phrases which are typical for advertisements, e.g. “Ad”, “Advertisement”, “Ads by Google”) and/or other techniques (e.g., additional check of element's parent element and/or child element(s), analyzing the text representation of web page using the innerHTML/outerHTML properties, etc.) User preferences, such as an exception list (white list) may be taken into account when making the decision.

All the data used for advertisements blocks identifying (e.g. URLs, patterns, tag names and it's properties values, CSS rules, typical strings, etc.) can be stored in the filtering rules database, which is downloaded from the server prior to the first run and stored locally. Also, this database is periodically updated (e.g., every 5 days) by downloading a new version from server and storing this new version locally. To guarantee the integrity of downloaded database, the checksum check is performed before saving downloaded data locally. The rules database operation flow after the application starts may be following:
check a local copy of the database;
if a local copy was found, prepare it for using in analysis module; and
check the date and time of the last successful database download. If the current local copy is out of date, start to downloading new version from a server;
if a local copy is not found, start downloading database from the server;
after a successful download, store database locally, store the date and time of last download and prepare database for using in analysis module;

The downloading and integrity check process may be following:
download data from server
check the checksum of the downloaded data
if the download failed or checksum check failed, postpone the next try (e.g., for 1 minute)
if the second try also failed wait until the next start of the client application. The checksum check may be based on hashes, such as MD5, CRCs, etc.

In additional to the default rules database, client software may provide user with the ability to add additional rules sets for analysis module. Such rule sets may be provided by third parties or maintained by the user himself. These rules may take into account, for example, local conditions, language specifics, etc., and thus increase the quality of advertisement detection. The client application may use the same approach for downloading and storing as for default rules database for these additional rule sets.

Monitoring of the page changes may be performed using one of the following techniques:
check by a timer—the client software performs periodic reprocessing of the page, and detects and replaces all advertising blocks, which were added after the previous processing;
by subscribing to DOM Level 3 mutation events—the client software subscribes to the DOM Level 3 mutation events (e.g. DOMNodeInserted, DOMSubtreeModified), provided by the browser. When a page is changed, the event fires (i.e., the browser, during the actual modifying of the page, informs the subscribers, who was subscribed to the corresponding events, about such a changes via the calling the handler, which was passed to the browser during the subscription process, and passing to the handler an “event” object, which contains information about the actual page change) and the event handler is called and added or changed node (or DOM subtree) are received in event handler and then is processed.
by using Mutation Observers—the client software starts observation of the pages changes using the Mutation Observers API, provided by the browser. When the page changes, the observer handler is called and information about the type of changes and corresponding changed nodes/subtrees are passed to the handler and then is processed;
other techniques, such as periodically comparing the text representation of the page, including all HTML tags (using the innerHTML/outerHTML properties), etc.

The alternative approaches to advertisements replacement with the widgets may be used. For example:
high-level interception of a browser's request with filtering, identifying and modifying the advertising blocks “on the fly”. The browser-specific traffic interception mechanisms can be used for this, such as MIME-filters for Microsoft Internet Explorer, chrome.webRequest API for Google Chrome or Chromium and analogous APIs for other browsers
low-level traffic filtering via insertion of client software into the network input/output driver stack, or installing it as an operating system kernel module, etc.
low-level traffic filtering via intercepting the system calls to the functions of network subsystem (e.g., Winlnet subsystem for MICROSOFT WINDOWS). This can be achieved by installing hooks on these functions.

For the Internet Explorer browser, there are known issues in COM event processing for plug-ins. For example, if a user loads a web page and then refreshes this page via the F5 hot key, the plug-in will not receive ready notification for web page and thus will not have the ability to start the web page processing. To address these issues, additional handlers for JavaScript events are implemented as follows:

1. Plug-in attaches to the browser's COM events;

2. When a browser is downloading the document, the plug-in receives the instance of document being downloading and attaches to its “onload” event (normally this event is handled by the JavaScript code on the page, not by the plug-in code).

3. When a document is downloaded completely, the “onload” event is fired (i.e. the browser informs the plug-in, that the subscribed event occurred by calling the event handler, specified during event subscription, and passing to this event handler the information about the event occurred), the plug-in handles this event and may start the web-page processing.

Note that “DOMContentLoaded” or other JavaScript events may be used in this approach instead or in addition to the “onload” event.

According to the exemplary embodiment, the ads can be replaced by the following exemplary types of widgets:
widgets displaying notification and updates from the social networks (e.g., Twitter or Facebook);
widgets displaying feeds (including friend feeds) from social networks and blogs (e.g., livejournal, Twitter, wordpress, Facebook, MySpace, etc.)
widgets displaying current weather and weather forecasts for a local area of the user;
widgets displaying local news;
widgets displaying information related to a current site (i.e., the site where the widget is placed—links to other site or social networks, etc.);
widgets displaying references to the sites similar to the current site or page;
widgets allowing to go over the pages in social networks (e.g. showing random image from user's friend's album in Facebook with link to that album, showing a list of links recently shared by friend in Facebook, showing trends from Twitter with links to the corresponding search results, showing user's pictures from Pinterest or most interesting/popular images from Pinterest with a link to the corresponding pages);
widgets displaying search results based on content of the current site or the search query used to get to this site or page;
widgets displaying results based on a user search query that led the user to the current site;
widgets displaying search results based on the reference that led the user to the current site;
widgets displaying stock quotes and market statistics;
widgets displaying YouTube videos. Selection of the video can be done on the server side, for example, based on data sent by the plugin to the server regarding user preferences, searches, social network profile, and so on;
widgets displaying games, e.g., Fifteen Puzzle, noughts and crosses, sapper, etc.
widgets displaying works of art and other artistic image content;
widgets displaying news related to currently viewed site or page;
widgets displaying quotes from services, such as Wikiquote;
widgets allowing to post information to the social networks (e.g., post tweets to Twitter, change Facebook status, etc.);
widgets displaying current weather and/or weather forecasts for a location, specified by the user;
widgets displaying news on topics or keywords, specified by the user;
widgets displaying a current time in specified time zone (or geographic area);
widgets displaying links to the sites, which may be interesting for user. Selection of the sites can be done on the server side, for example, based on data sent by the plugin to the server regarding user preferences, searches, social network profile, and so on;
widgets displaying interesting facts (e.g. “Tarantulas have retractable claws on each leg, like cats.”). Selection of the facts can be done on the server side by picking them randomly or pseudorandomly or in a targeted manner, for example, based on data sent by the plugin to the server regarding user preferences, searches, social network profile, and so on;
widgets displaying the list of the nearby holidays in the geographic region defined by the IP address of the user's connection.

The exemplary embodiment of the special behavior on certain sites and/or web pages may act as follows. For the Google search results page, the client application can add additional search results, obtained from other sources (e.g. Twitter results, Bing search results, search results from Wikipedia, etc.). On the Google search results page there is a right margin of search results block. This margin is normally reserved for additional information, such as map snippets, brief overview of the search term, advertisements block, etc. Often, this margin is empty. The client application can use this margin to place the additional search results block there. If the margin is empty, the additional block may be added directly at the top of the margin. If the margin not empty, but does not contain any advertisements, the additional results block may be added under Google's additional information (e.g., map snippets, brief overview of the search terms). If the margin contains an advertisement block, the client application can overlay this advertisements block with additional search results block. The original search results page layout and functionality is preferably preserved. The client software may provide to the user the ability to dynamically switch between additional search results block and original advertisements block. When the user goes over the Google's search results pages, the additional search results may be automatically and synchronously paginated relative to the current Google's search results page.

The user may be provided, for example, with following modes for this special behavior:
always on: the additional search results block is inserted in any Google's search result page, regardless with the presence of the advertisement block;
conditional: the additional search results is inserted in the Google's search results only when the advertisements block is present on the right margin of the search results web page;
always off: the additional search results block is not inserted in any Google's search results page.

The user can select the desired mode in the settings dialog described below.

For the Facebook home page the special behavior may be implemented for adding the additional block with information from the other social networks (e.g., Twitter) on the Facebook pages. Facebook pages have a right margin. This margin normally used for advertisement blocks or may be empty. The client application can use this margin to place the additional block with information from other social networks. If the margin is empty, the additional block may be added directly on the top of the margin. If the margin contains advertisements block, the client application may overlay this advertisements block with additional block with information from other social networks. The original page layout and functionality is completely preserved. The client software may provide to the user the ability to dynamically switch between the additional block and original advertisement block.

The client application may provide to the user the ability to switch such this special behavior on or off, as described below.

For those pages, where special behavior is used, the standard advertisements detection and replacement mechanism may be turned off.

The client software may make a decision if any of special behavior should be used for certain web page and select certain behavior for the page, based on the page domain, URL, presence of predefined elements in the DOM, etc.

In additional to the preferences, described above, the client software may provide the user additional preferences options, which can configure the behavior of the analysis module and special behaviors on the certain sites/pages. For example, the user can select:
which advertisements should be replaced: none, all or just animated advertisements;
how the advertisements with dimensions, which is not suitable for replacement with the widgets, should be processed: do nothing with them or completely hide these advertisements blocks;
turn on or off the special behavior on the certain sites/pages, or configure page-specific options for concrete behavior;
add, modify or remove the items from “white list” of domains, for which advertisements are not replaced;
add or remove the additional sets of rules for analysis module;
other parameters of client software (e.g. preferred language, geographical location, rules database update interval, etc.).

The option dialog may be accessed with number of ways, including the quick access via the pop-up panel, showed on the mouse hover on the widgets.

As part of client software, the statistics subsystem may be implemented. This subsystem may send to the server information about the software functioning of the software (e.g. runs number, count of advertisements found, count of widgets successfully inserted instead of advertisements blocks, number of successful injection of the additional search results block in the Google's search results page, etc.). Collecting and analyzing of this information may help with detection of problems in the software functionality; detect the changes of the certain pages or sites (such as Google's search results, Facebook pages) and prepare updates as soon as possible; and gather other information useful about the software functioning (e.g., how many active users are using the software, which versions are used, which features are turned on or off, etc.). All gathered information may be provided in different ways, including but no limited to accumulated form and the form of a function from the time.

In additional to the “normal” stand-alone version of the client software, the implementation of the client software may be provided as set of isolated modules or self-installation package, thus the functionality of client software may be bundled with other software.

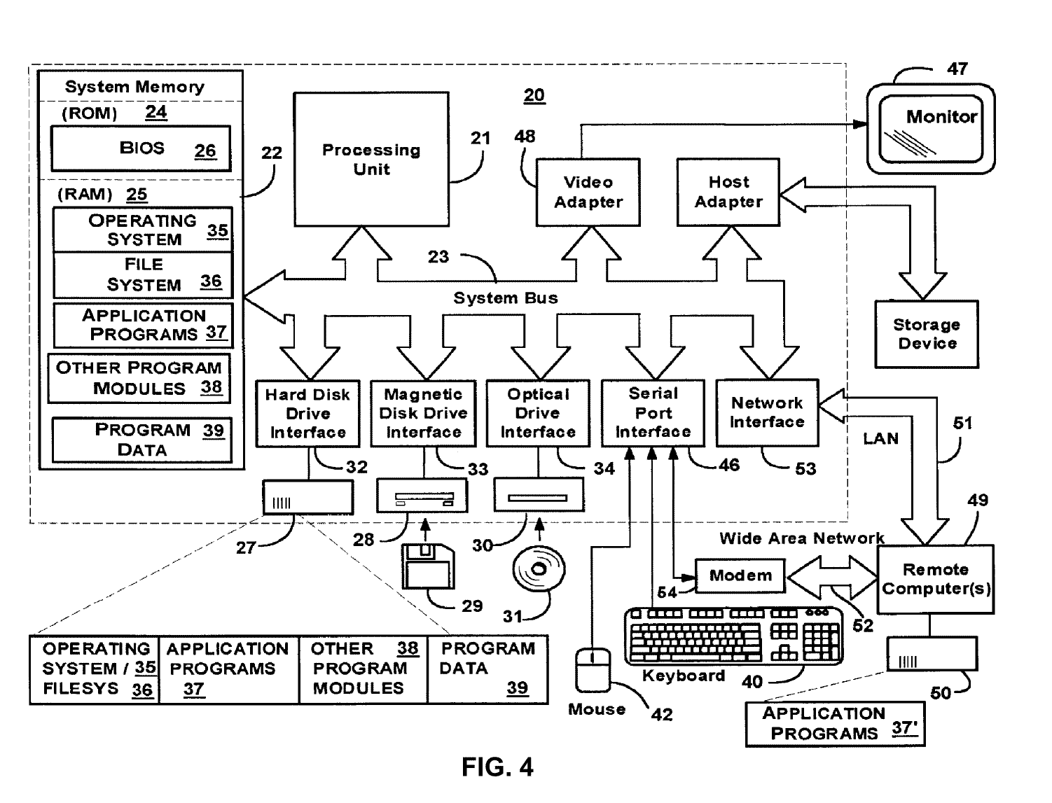

With reference to FIG. 4, an exemplary system for implementing the invention includes a general purpose computing device in the form of a computer or server 20 or the like, including a processing unit 21, a system memory 22, and a system bus 23 that couples various system components including the system memory to the processing unit 21.

The system bus 23 may be any of several types of bus structures including a memory bus or memory controller, a peripheral bus, and a local bus using any of a variety of bus architectures. The system memory includes read-only memory (ROM) 24 and random access memory (RAM) 25. A basic input/output system 26 (BIOS), containing the basic routines that help to transfer information between elements within the personal computer 20, such as during start-up, is stored in ROM 24.

The computer (or server) 20 may further include a hard disk drive 27 for reading from and writing to a hard disk, not shown, a magnetic disk drive 28 for reading from or writing to a removable magnetic disk 29, and an optical disk drive 30 for reading from or writing to a removable optical disk 31 such as a CD-ROM, DVD-ROM or other optical media. The hard disk drive 27, magnetic disk drive 28, and optical disk drive 30 are connected to the system bus 23 by a hard disk drive interface 32, a magnetic disk drive interface 33, and an optical drive interface 34, respectively.

The drives and their associated computer-readable media provide non-volatile storage of computer readable instructions, data structures, program modules and other data for the personal computer 20. Although the exemplary environment described herein employs a hard disk, a removable magnetic disk 29 and a removable optical disk 31, it should be appreciated by those skilled in the art that other types of computer readable media that can store data that is accessible by a computer, such as magnetic cassettes, flash memory cards, digital video disks, Bernoulli cartridges, random access memories (RAMs), read-only memories (ROMs) and the like may also be used in the exemplary operating environment.

A number of program modules may be stored on the hard disk, magnetic disk 29, optical disk 31, ROM 24 or RAM 25, including an operating system 35 (preferably Windows™ 2000). The computer 20 includes a file system 36 associated with or included within the operating system 35, such as the Windows NT™ File System (NTFS), one or more application programs 37, other program modules 38 and program data 39. A user may enter commands and information into the personal computer 20 through input devices such as a keyboard 40 and pointing device 42. Other input devices (not shown) may include a microphone, joystick, game pad, satellite dish, scanner or the like.

These and other input devices are often connected to the processing unit 21 through a serial port interface 46 that is coupled to the system bus, but may be connected by other interfaces, such as a parallel port, game port or universal serial bus (USB). A monitor 47 or other type of display device is also connected to the system bus 23 via an interface, such as a video adapter 48. In addition to the monitor 47, personal computers typically include other peripheral output devices (not shown), such as speakers and printers.

The computer 20 may operate in a networked environment using logical connections to one or more remote computers 49. The remote computer (or computers) 49 may be another personal computer, a server, a router, a network PC, a peer device or other common network node, and typically includes many or all of the elements described above relative to the personal computer 20, although only a memory storage device 50 has been illustrated. The logical connections include a local area network (LAN) 51 and a wide area network (WAN) 52. Such networking environments are commonplace in offices, enterprise-wide computer networks, Intranets and the Internet.

When used in a LAN networking environment, the personal computer 20 is connected to the local network 51 through a network interface or adapter 53. When used in a WAN networking environment, the computer 20 typically includes a modem 54 or other means for establishing communications over the wide area network 52, such as the Internet. The modem 54, which may be internal or external, is connected to the system bus 23 via the serial port interface 46.

In a networked environment, program modules depicted relative to the computer 20, or portions thereof, may be stored in the remote memory storage device. It will be appreciated that the network connections shown are exemplary and other means of establishing a communications link between the computers may be used.

Having thus described a preferred embodiment, it should be apparent to those skilled in the art that certain advantages of the described method and computer program product have been achieved. In particular, it should be appreciated by those skilled in the art that the widgets replace ad banners and provide for rendering of customized useful information on the web pages viewed by the users instead of useless commercial ads.

It should also be appreciated that various modifications, adaptations, and alternative embodiments thereof may be made within the scope and spirit of the present invention. The invention is further defined by the following claims.

What is claimed is:

1. A method for customizing web pages, the method comprising:
scanning a user computer;
defining a set of user preferences based on information identified in the scanning process;
downloading web pages to the user computer;
scanning the web pages for ad banners based on any of known URLs, HTML tag names, properties and attributes, CSS-rules, full text search results and mask templates matching over part of or all listed values;
defining sizes and locations of the ad banners;
replacing the ad banners by the widgets of the same size;
populating the widgets by downloading content based on the user preferences; and
rendering dynamic content to the user.

2. The method of claim 1, where any of the following content is used to populate the widgets:
links to the websites of interest to the user;
interesting facts;
famous quotes;
a link to a webpage pointing with more detailed information about a topic of the current webpage; and
information derived from a webpage being displayed in the browser.

3. The method of claim 1, where any of the following content is used to populate the widgets:
links shared by friends from social networks;
links shared by friends from social networks depending on a search request by which the user found the page being viewed now links shared by friends from social networks depending on the page from which the user reached the current page;
notifications and updates from the social networks;
feeds from social networks or blogs;
pages or page fragments from social networks; and
an application allowing user to post information to the social networks.

4. The method of claim 1, where any of the following content is used to populate the widgets:
current weather or weather forecast for a local area of the user;
current weather or weather forecast for a location specified by the user;
local news;
news related to the current webpage;
news for topics specified by the user;
links to webpages similar to the current webpage; and
stock quotes and stock market statistics.

5. The method of claim 1, where any of the following content is used to populate the widgets:
search results based on content of the current webpage;
search results based on a search query used to get to the current webpage; and
search results based on a reference that led the user to the current webpage.

6. The method of claim 1, where any of the following content is used to populate the widgets:
videos;
games;
works of art or artistic images;
a current time in specified time zone or geographic area; and
a list of holidays in the user's geographic areas.

7. The method of claim 1, wherein the only animated banners are replaced by the widgets.

8. The method of claim 1, wherein the animated banners are flash banners.

9. The method of claim 1, wherein the animated banners are svg banners.

10. The method of claim 1, wherein the animated banners are gif banners.

11. The method of claim 1, wherein any of the following techniques of advertisement filtering is used:
page scan after a page ready or with page change events;
page scan after the page ready and a periodic rescan to detect page changes;
“on the fly” requests scan using an API of the browser;
scan using a module installed into a network input/output driver stack;
scan using a module installed into the operating system kernel; and
scan using network subsystem call interception via hook installation.

12. The method of claim 1, wherein the user specifies a whitelist of domains, where advertisements that are not replaced.

13. The method of claim 1, wherein the browser is Internet Explorer, and a page ready event is handled via a JavaScript event in the plug-in.

14. The method of claim 1, wherein the advertisements detection rules database is updated from a server.

15. The method of claim 14, wherein data integrity checks are used to check the database.

16. The method of claim 1, wherein additional rule sets for advertisement detection are manually specified by the user.

17. The method of claim 16, wherein the additional specified rules sets are updated from a server.

18. The method of claim 1, wherein the client software is configured via a settings dialog box.

19. A method for customizing web pages, the method comprising:
scanning a user computer;
defining a set of user preferences based on information identified in the scanning process;
downloading web pages to the user computer;
scanning the web page for the keywords;
searching social networks using the keywords;
scanning the web pages for ad banners, based on known URLs; HTML tag names, properties and attributes; CSS-rules; full search results or mask templates over part of or all listed values;
defining sizes and locations of the ad banners;
replacing the ad banners by the widgets of the same size;
populating the widgets by set of interesting links taken from the user's social network subscription, which correspond to the content of web page; and
rendering dynamic content to the user.

20. A method for customizing web pages, the method comprising:
scanning a user computer;
defining a set of user preferences based on information identified in the scanning process;
downloading web pages to the user computer;
scanning the web pages for keywords;
scanning the web pages for ad banners, based on known URLs; HTML tag names, properties and attributes; CSS-rules; full search results or mask templates over part of or all listed values;
defining sizes and locations of the ad banners;
replacing the ad banners with widgets of the same size;
populating the widgets with dynamic content in a form of quotes corresponding to the keywords from the webpage; and
rendering the dynamic content in the widgets to the user.

21. A method for customizing web pages, the method comprising:
scanning a user computer;
defining a set of user preferences based on information identified in the scanning process;
downloading web pages to the user computer;
detecting the type of the web page;
determining the appropriate special behavior for the web page;
applying the special behavior to the web page;
inserting block with additional information on the web page;
populating the block with additional information with dynamic content and;
rendering the dynamic content in the widgets to the user.

22. The method of claim 21, wherein the special behavior adds the additional search results from external sources into the search machine's search results page.

23. The method of claim 21, wherein the special behavior adds to the pages of social networks the additional block with information from other social networks.
